(19) United States
(12) Patent Application Publication
(10) Pub. No.: US 2026/0268813 A1
(43) Pub. Date: Sep. 10, 2026

(54) DISPLAY CONTROL METHOD AND APPARATUS, HEAD-MOUNTED DISPLAY DEVICE, AND MEDIUM

(71) Applicant: GOERTEK INC., Weifang, Shandong (CN)

(72) Inventors: Mingming YANG, Weifang, Shandong (CN); Wen WANG, Weifang, Shandong (CN); Yongfu CHEN, Weifang, Shandong (CN)

(21) Appl. No.: 18/994,889

(22) PCT Filed: Aug. 8, 2023
(86) PCT No.: PCT/CN2023/111782

§ 371 Date: Jan. 15, 2025

(30) Foreign Application Priority Data
Sep. 29, 2022 (CN) 202211203825.4

(51) Int. Cl. G09G 3/00; G06F 3/01

(52) U.S. Cl. CPC G09G 3/001; G06F 3/017; G09G 2340/0464; G09G 2354/00

(57) ABSTRACT

A display control method and apparatus (400), a head-mounted display device (500, 1000), and a medium. The method comprises: using a first virtual screen (1) among a plurality of virtual screens (1, 2, 3, 4) as a main display screen of a head-mounted display device (500, 1000), and determining whether display content of second virtual screens (2, 3, 4) among the plurality of virtual screens (1, 2, 3, 4) is updated (S2100), part of the plurality of virtual screens (1, 2, 3, 4) being within the field of view of a wearer of the head-mounted display device (500, 1000); and outputting first prompt information on the first virtual screen (1) when the display content of any of the second virtual screens (2, 3, 4) is updated (S2200).

This application claims priority to a Chinese patent application No. 202211203825.4, entitled “DISPLAY CONTROL METHOD AND APPARATUS, HEAD-MOUNTED DISPLAY DEVICE, AND MEDIUM”, filed with the China Patent Office on Sep. 29, 2022, the entire contents of which are incorporated by reference in this application.

### TECHNICAL FIELD

The embodiments of the present disclosure relate to the technical field of wearable devices, and more specifically, to a display control method, a display control apparatus, a head-mounted display device, and a computer-readable storage medium.

### BACKGROUND

In the related art, taking a head-mounted display device as smart glasses such as AR glasses as an example, usually, a plurality of display screens can be placed on the Launcher (desktop system launcher) of the AR glasses at the same time, and the applications on these a plurality of display screens are all foreground applications, that is, the application on each virtual screen is the foreground application.

Usually, only part of the plurality of display screens are located in the field of view of the wearer of the head-mounted display device at the same time, and the user needs to turn around to interact with other display screens. In this way, when the user uses one of the display screens, he or she can only see the information on that display screen, but cannot see the information on other display screens. At this time, if there are new messages or data on other screens, there is no way to notify the user in time.

### SUMMARY

One purpose of the embodiments of the present disclosure is to provide a new technical solution for display control.

According to a first aspect of an embodiment of the present disclosure, a display control method is provided, the method including:
using a first virtual screen among a plurality of virtual screens as a main display screen of a head-mounted display device, and determining whether display content of second virtual screens among the plurality of virtual screens is updated; wherein part of the plurality of virtual screens are located in a visual field area of a wearer of the head-mounted display device;
when the display content of any of the second virtual screens is updated, outputting first prompt information on the first virtual screen.

Optionally, the determining whether the display content of any of the second virtual screens is updated includes:
acquiring a current first display data frame and a latest second display data frame of the any of the second virtual screens;
comparing the first display data frame with the second display data frame to obtain a comparison result;
when the comparison result indicates that there is a difference between the first display data frame and the second display data frame, indicating that the display content of the any of the second virtual screens is updated.

Optionally, the outputting first prompt information on the first virtual screen when the display content of any of the second virtual screens is updated includes:
when the display content of the any of the second virtual screens is updated, acquiring attribute information of the any of the second virtual screen; and
displaying a display control element matching the attribute information of the any of the second virtual screens, on the first virtual screen.

Optionally, the method further includes:
when the display content of any of the second virtual screens is updated, acquiring a set mapping data; wherein the mapping data reflects position information and attribute information of different virtual screens;
determining position information of the any of the second virtual screens according to the mapping data and the attribute information of the any of the second virtual screens;
determining prompt identification information of the any of the second virtual screens based on the position information of the any of the second virtual screens;
highlighting the prompt identification information of the any of the second virtual screens.

Optionally, after the outputting the first prompt information on the first virtual screen, the method further includes:
receiving a first input for the display control element;
updating a display position of the any of the second virtual screens in response to the first input; and
when updating the display position of the any of the second virtual screens, modifying a set mapping data; wherein the mapping data reflects the position information and the attribute information of different virtual screens;
wherein, the updating the display position of the any of the second virtual screens in response to the first input includes: interchanging the display position of the any of the second virtual screens and a display position of the first virtual screen.

Optionally, the method further includes:
acquiring attribute information of an application operated on the first virtual screen in response to the first input; and
when the attribute information of the application is in a list of set application attributes, pausing playing of a target video according to the application;
wherein the list of set application attributes includes attribute information of a plurality of different video applications.

Optionally, the method further includes:
receiving a second input for the any of the second virtual screens; and in response to the second input, deleting the first prompt information, and stopping highlighting the prompt identification information of any of the second virtual screens;
wherein the receiving the second input for the any of the second virtual screens includes one of:
receiving a touch event of a user on the any of the second virtual screens;
receiving a ray event sent by a controller to the any of the second virtual screens; and
receiving a gesture event operated by a user to the any of the second virtual screens.

According to a second aspect of an embodiment of the present disclosure, a display control apparatus is provided, the apparatus including:
a determination module configured to use a first virtual screen among a plurality of virtual screens as a main display screen of a head-mounted display device, and determine whether display content of second virtual screens among the plurality of virtual screens is updated; wherein part of the plurality of virtual screens are located in a visual field area of a wearer of the head-mounted display device; and
an output module configured to output first prompt information on the first virtual screen when the display content of any of the second virtual screens is updated.

According to a third aspect of an embodiment of the present disclosure, a head-mounted display device is provided, including:
a memory configured to store executable computer instructions; and
a processor configured to execute the display control method as described in the first aspect under control of the executable computer instructions.

According to a fourth aspect of an embodiment of the present disclosure, a computer-readable storage medium in which computer instructions are stored is provided, wherein the computer instructions are executed by a processor to execute the display control method as described in the first aspect.

One beneficial effect of the embodiments of the present disclosure is that, when part of the plurality of virtual screens are located in the field of view of the wearer of the head-mounted display device, the first virtual screen among the plurality of virtual screens can be used as the main display screen of the head-mounted display device, and when the display content of the second virtual screen among the plurality of virtual screens is updated, although the second virtual screen may not be located in the field of view of the wearer, the first prompt information can be directly output on the first virtual screen, so that the user can quickly switch to the any of the second virtual screens based on the first prompt information.

Other features and advantages of the present specification will become apparent from the following detailed description of exemplary embodiments of the present specification with reference to the accompanying drawings.

### BRIEF DESCRIPTION OF DRAWINGS

The accompanying drawings, which are incorporated in and constitute a part of the specification, illustrate embodiments of the specification and, together with the description, serve to explain the principles of the specification.

FIG. 1 is a schematic diagram of a hardware configuration of a head-mounted display device according to an embodiment of the present disclosure;

FIG. 2 is a schematic flow chart of a display control method according to an embodiment of the present disclosure;

FIG. 3 is a schematic diagram of a display of a virtual screen according to an embodiment of the present disclosure;

FIG. 4 is a schematic principle diagram of a display control apparatus according to an embodiment of the present disclosure; and

FIG. 5 is a schematic diagram of a head-mounted display device according to an embodiment of the present disclosure.

### DETAILED DESCRIPTIONS

Various exemplary embodiments of the present disclosure will now be described in detail with reference to the accompanying drawings. It should be noted that unless otherwise specifically stated, the relative arrangement of components and steps, numerical expressions and numerical values set forth in these embodiments do not limit the scope of the embodiments of the present disclosure.

The following description of at least one exemplary embodiment is merely illustrative in nature and is in no way intended to limit the present disclosure, its application, or uses.

The technologies, methods and device known to those skilled in the art may not be discussed in detail, but where appropriate, the technologies, methods and device should be considered as part of the specification.

In all examples shown and discussed herein, any specific values should be interpreted as merely exemplary and not limiting. Therefore, other examples of the exemplary embodiments may have different values.

It should be noted that like reference numerals and letters refer to similar items in the following figures, and therefore, once an item is defined in one figure, it need not be further discussed in subsequent figures.

### Hardware Configuration

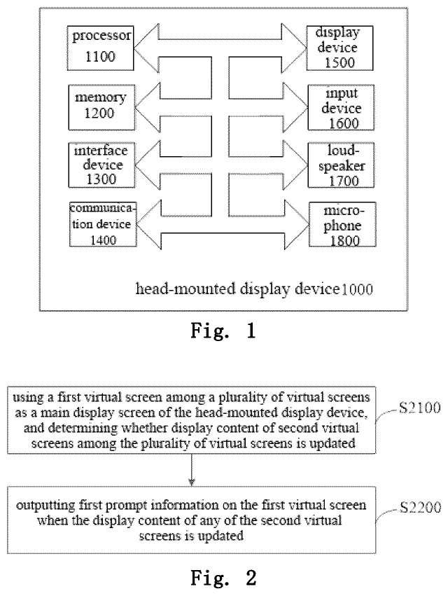

FIG. 1 is a block diagram of a hardware configuration of a head-mounted display device 1000 according to an embodiment of the present disclosure.

As shown in FIG. 1, the head-mounted display device 1000 may be smart glasses, and the smart glasses may be AR glasses, and of course may be other devices, which is not limited in the embodiments of the present disclosure.

In one embodiment, as shown in FIG. 1, the head-mounted display device 1000 may include a processor 1100, a memory 1200, an interface device 1300, a communication device 1400, a display device 1500, an input device 1600, a loudspeaker 1700 and a microphone 1800, and the like.

Among them, the processor 1100 may include but is not limited to a central processing unit CPU, a microprocessor MCU, etc. The memory 1200 includes, for example, a ROM (read-only memory), a RAM (random access memory), a non-volatile memory such as a hard disk, etc. The interface device 1300 includes, for example, various bus interfaces, such as a serial bus interface (including a USB interface), a parallel bus interface, etc. For example, the communication device 1400 is capable of wired or wireless communication. The display device 1500 is, for example, a liquid crystal display, an LED display, an OLED (Organic Light-Emitting Diode) display, etc. The input device 1600 includes, for example, a touch screen, a keyboard, a controller, etc. The head-mounted display device 1000 can output audio information through a loudspeaker 1700 and can collect audio information through a microphone 1800.

Those skilled in the art should understand that, although multiple devices of the head-mounted display device 1000 are shown in FIG. 1, the head-mounted display device 1000 of the embodiment of this specification may only involve part of the multiple devices, or may also include other devices, which is not limited here.

In this embodiment, the memory 1200 of the head-mounted display device 1000 is configured to store instructions, which are configured to control the processor 1100 to operate to implement or support the implementation of the display control method according to any of the embodiments. Those skilled in the art can design instructions according to the solutions disclosed in this specification. How the instructions control the processor to operate is well known in the art, so it will not be described in detail here.

In the above description, those skilled in the art can design instructions according to the solutions provided by the present disclosure. How instructions control the processor to operate is well known in the art, so it will not be described in detail here.

The head-mounted display device shown in FIG. 1 is illustrative only and is in no way intended to limit the present disclosure, its applications, or uses.

Hereinafter, various embodiments and examples according to the present disclosure are described with reference to the drawings.

### Method Embodiment

FIG. 2 shows a display control method according to an embodiment of the present disclosure. The display control method may be implemented by a head-mounted display device, or may be implemented in common by a control apparatus independent of the head-mounted display device and the head-mounted display device, or may be implemented in common by a cloud server and the head-mounted display device.

As illustrated in FIG. 2, the display control method of this embodiment may include the following steps S2100 to S2200:

Step S2100: using a first virtual screen among a plurality of virtual screens as a main display screen of a head-mounted display device, and determining whether display content of second virtual screens among the plurality of virtual screens is updated.

Wherein part of the plurality of virtual screens are located in the field of view of the wearer of the head-mounted display device. The field of view of the wearer refers to the field of view of the wearer's eyes, and the viewing angle of the field of view is usually less than or equal to 180 degrees. It is understandable that when the wearer wears the head-mounted display device, the head-mounted display device is worn in a manner such that its directivity is forward and its viewing angle is less than or equal to 180 degrees.

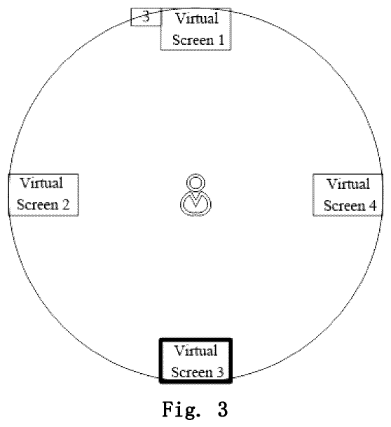

The first virtual screen is a display screen within the field of view of the wearer of the head-mounted display device. Taking the head-mounted display device as smart glasses such as AR glasses as an example, as shown in FIG. 3, four virtual screens, namely virtual screen 1, virtual screen 2, virtual screen 3, and virtual screen 4, are placed on the desktop launcher ‘Launcher’ of the head-mounted display device at the same time, and these four virtual screens are disposed in a manner of 360° surrounding the wearer of the user's head-mounted display device, that is, only one display screen is within the wearer's field of view at the same time.

It is understandable that the plurality of display screens described above may also be semi-surrounding or irregularly distributed in space, etc., and this embodiment is not limited thereto.

Referring to FIG. 3, virtual screen 1 is the first virtual screen, which is a display screen within the current field of view of the wearer of the AR glasses. Here, virtual screen 1 can be used as the main display screen.

The second virtual screens are virtual screens other than the main display screen. Referring to FIG. 3, virtual screen 1 is the first virtual screen, and here, virtual screen 1 can be used as the main display screen. At the same time, virtual screen 2, virtual screen 3, and virtual screen 4 are all second virtual screens.

In one embodiment, determining whether the display content of any of the second virtual screens is updated may further include the following steps S3100 to S3300:

Step S3100, acquiring the current first display data frame and the latest second display data frame of the any of the second virtual screens.

Optionally, any of the second virtual screens may be screenshotted according to a set screenshot period, and the screenshot image of the current screenshot period may be obtained. Referring to FIG. 3, virtual screen 1 is used as the main display screen, and other virtual screens are the second virtual screens. As an example, taking the second virtual screen is virtual screen 3, the second virtual screen may be screenshotted based on the set screenshot period, and then the current screenshot image may be obtained as the first display data frame, and the latest screenshot image may be obtained as the second display data frame.

Optionally, the display data frame of any of the second virtual screens may be screenshotted based on a data frame screenshot tool such as an imageReader tool. Of course, the display data frame of any of the second virtual screens may also be acquired based on other methods, which is not limited in this embodiment.

Step S3200: comparing the first display data frame and the second display data frame to obtain a comparison result.

In this step S3200, each pixel of the first display data frame and the second display data frame may be compared. Continuing with the above example, each pixel of the first display data frame and the second display data frame of the virtual screen 3 may be compared.

Step S3300: when the comparison result indicates that there is a difference between the first display data frame and the second display data frame, it indicates that the display content of the second virtual screen is updated.

Continuing with the above example, when there is a difference in the pixel points between the first display data frame and the second display data frame of the virtual screen 3, it indicates that the display content of the virtual screen 3 is updated.

Then, the process proceeds to step S2200, wherein, outputting first prompt information on the first virtual screen when the display content of any of the second virtual screens is updated.

In one embodiment, the step S2200 that outputting first prompt information on the first virtual screen when the display content of any of the second virtual screens is updated, may further include the following steps S2210 to S2220:

Step S2210: when the display content of the any of the second virtual screens is updated, acquiring the attribute information of the any of the second virtual screens.

The attribute information of the second virtual screen may be ID information of the second virtual screen, which may uniquely identify the second virtual screen.

Step S2220: displaying a display control element matching the attribute information of the any of the second virtual screens, on the first virtual screen.

Continuing with the above example, referring to FIG. 3, when the display content of virtual screen 3 is updated, a corner mark control element matching the ID information of virtual screen 3 can be displayed on virtual screen 1 based on the ID information of virtual screen 3 to prompt the wearer that the display content of virtual screen 3 is updated. At this time, virtual screen 3 needs to be switched to the main display screen for display.

According to the method of an embodiment of the present disclosure, when part of the plurality of virtual screens are located in the field of view of the wearer of the head-mounted display device, the first virtual screen among the plurality of virtual screens can be used as the main display screen of the head-mounted display device, and when the display content of the second virtual screen among the plurality of virtual screens is updated, although the second virtual screen may not be located in the field of view of the wearer, the first prompt information can be directly output on the first virtual screen, so that the user can quickly switch to the any of the second virtual screen based on the first prompt information.

In one embodiment, the display control method of the embodiment of the present disclosure may further include the following steps S4100 to S4400:

Step S4100: when the display content of any of the second virtual screens is updated, acquiring the set mapping data.

The mapping data reflects the position information and the attribute information of different virtual screens, wherein the position information of the virtual screen is the position of the virtual screen on the Launcher, and the attribute information of the virtual screen may be the ID information of the virtual screen.

Step S4200: determining the position information of any of the second virtual screen according to the mapping data and the attribute information of any of the second virtual screen.

Exemplarily, the set mapping data may include four correspondences, wherein one correspondence may be the position information of virtual screen 1 and the ID information of virtual screen 1, another one correspondence may be the position information of virtual screen 2 and the ID information of virtual screen 2, further another one correspondence may be the position information of virtual screen 3 and the ID information of virtual screen 3, and the remaining one correspondence may be the position information of virtual screen 4 and the ID information of virtual screen 4.

Furthermore, the mapping data may be generated before step S4100. For example, when a virtual screen is created on the Launcher of the head-mounted display device, usually, an ID information is assigned to each created virtual screen, and in the meanwhile, the position information of the virtual screen, such as the coordinate information of the upper left corner of the virtual screen, and the width and height of the virtual screen are recorded. Here, the above mapping data can be obtained according to the ID information assigned to the created virtual screen and the position information of the virtual screen.

Continuing with the above example, based on the ID information of the virtual screen 3, the location information corresponding to the ID information of the virtual screen 3 can be found from the set mapping data.

Step S4300: determining the prompt identification information of the second virtual screen based on the position information of the second virtual screen.

The prompt identification information may be a border of any of the second virtual screen. Of course, the prompt identification information may also be other reminder identification representing the attributes of the second virtual screens, which is not limited in this embodiment.

Step S4400: highlighting the prompt identification information of any of the second virtual screen.

Continuing with the above example, referring to FIG. 3, after determining the position information corresponding to the ID information of virtual screen 3, the border of virtual screen 1 can be determined based on the position information, and the border of the second virtual screen can be marked red (shown in bold black), or the border of virtual screen 3 can be controlled to shake, or the border of virtual screen 3 can be controlled to deform, so as to facilitate the wearer to find virtual screen 3 in time by turning around.

In one embodiment, after the first prompt information is output on the first virtual screen, the display control method of the embodiment of the present disclosure further includes the following steps S5100 to S5300:

Step S5100: receiving a first input for the display control element.

Optionally, the first input may be a touch input to the display control element.

Optionally, the first input may also be a ray event sent by an interactive device to the display control element, and the interactive device may be a handle, a mouse, a mobile phone or other device.

Optionally, the first input may also be a gesture event operated by a user, i.e., a wearer, to the display control.

Step S5200: updating a display position of the any of the second virtual screens in response to the first input.

Optionally, the step S5200 that updating the display position of the any of the second virtual screens in response to the first input may further include: interchanging the position of the any of the second virtual screen and the position of the first virtual screen.

Continuing with the above example, for example, the position of virtual screen 1 and the position of virtual screen 3 can be interchanged. In this case, virtual screen 3 is used as the main display screen, thus ensuring that the wearer can process new messages in real time.

Step S5300: when the display position of the any of the second virtual screens is updated, modifying a set mapping data; wherein the mapping data reflects the position information and the attribute information of different virtual screens.

Continuing with the above example, after interchanging the position of virtual screen 1 and the position of virtual screen 3, the corresponding relationship in the mapping data can be modified, for example, the position information of virtual screen 1 can be updated to the position information of virtual screen 3, and the position information of virtual screen 3 can be updated to the position information of virtual screen 1.

In one embodiment, the display control method of the embodiment of the present disclosure may further include the following steps S6100 to S6200:

Step S6100: acquiring attribute information of an application operated on the first virtual screen, in response to the first input.

The attribute information of the application includes, for example but not limited to, the name of the application and the type of the application.

In this embodiment, after executing the above step S5100 to receive the first input for the identification control element, the property information of the application operated on the first virtual screen can be acquired in response to the first input according to this step S6100. Continuing with the above example, for example, the application operated on virtual screen 1 is application 1, and application 1 is a video application.

Step S6200: when the attribute information of the application in a list of set application attributes, pausing playing of a target video according to the application.

The list of set application attributes includes attribute information of a plurality of different video applications. It can be understood that the video application can be a game application. Exemplarily, the list of set application attributes includes application 1, application 2, and application 3.

Continuing with the above example, since application 1 is the list of set application attribute, therefore, when the user switches virtual screen 1 to the main display screen, pausing to playing the target video by the application 1 operated on virtual screen 1, to ensure that the user switches to virtual screen 1 next time, the target video can directly continue the previous to playback based on the pause time, thereby ensuring the playback continuity of the target video.

According to the embodiments of the present disclosure, when the user is watching a movie and there is a new message on other virtual screens and the user switches to the other virtual screens to process the new message, the movie watching will be automatically paused to ensure that the target video can directly continue the previous to playback based on the pause time when the user switches back next time, thereby ensuring the playback continuity of the target video and improving the user experience.

In one embodiment, the display control method of the embodiment of the present disclosure further includes the following steps S7100 to S7200:

Step S7100: receiving a second input for the any of the second virtual screens.

Here, the receiving the second input for the any of the second virtual screens includes one of the following: receiving a touch event of a user for any of the second virtual screens; receiving a ray event sent by an interactive device to the any of the second virtual screen; receiving a gesture event operated by the user to the any of the second virtual screens.

Step S7200: In response to the second input, deleting the first prompt information, and stopping highlighting the prompt identification information of the second virtual screen.

Continuing with the above example, after receiving the second input, the border of virtual screen 3 can be unmarked red, or the border of virtual screen 3 can be controlled not to shake, or the border of virtual screen 3 can be controlled not to deform, in response to the second input. At the same time, the corner mark control element of virtual screen 3 will be deleted from virtual screen 1.

### EXAMPLE

Next, taking the head-mounted display device as AR glasses as an example, an example display control method is shown. Referring to FIG. 3, the display control method may include the following steps:

Step S701: creating virtual screen 1, virtual screen 2, virtual screen 3, and virtual screen 4 on the AR Launcher, wherein virtual screen 1, virtual screen 2, virtual screen 3, and virtual screen 4 surround the wearer, and only virtual screen 1 is located in the wearer's field of view; assigning ID information to each virtual screen, and recording the position information of each virtual screen to establish mapping data.

Step S702: using virtual screen 1 as the main display screen.

Step S703, taking screenshots of virtual screen 2, virtual screen 3, and virtual screen 4 according to the set screenshot cycle, and acquiring screenshot images of the current screenshot cycle.

Step S704: if there is a difference between the current display data frame of virtual screen 3 and the latest display data frame, displaying a corner mark control element corresponding to the id information of virtual screen 3 on virtual screen 1 based on the id information of virtual screen 3; and determining the border of virtual screen 3 based on the mapping data and the id information of virtual screen 3 and marking the border of virtual screen 3 into red.

Step S705: interchanging virtual screen 1 and virtual screen 3 by the user to use virtual screen 3 as the main display screen, and canceling marking the border of virtual screen 3 into red, and deleting the corner mark control element corresponding to the ID information of virtual screen 3 from virtual screen 1. At the same time, the mapping data is updated.

Step S706: when the attribute information of the application operated on the virtual screen 1 is in the list of set application attribute, pausing playing of a target video based on the application.

### Apparatus Embodiment

FIG. 4 is a schematic diagram of the principle of a display control apparatus according to an embodiment. As shown in FIG. 4, the apparatus 400 includes a determination module 410 and an output module 420.

The determination module 410 is configured to use a first virtual screen among the plurality of virtual screens as a main display screen of a head-mounted display device, and determine whether display content of second virtual screen among the plurality of virtual screens is updated; wherein part of the plurality of virtual screens are located in a visual field of a wearer of the head-mounted display device;

The output module 420 is configured to output first prompt information on the first virtual screen when the display content of any of the second virtual screens is updated.

In one embodiment, the determination module 410 is configured to: acquire the current first display data frame and the latest second display data frame of the any of the second virtual screen; compare the first display data frame with the second display data frame to obtain a comparison result; when the comparison result indicates that there is a difference between the first display data frame and the second display data frame, it indicates that the display content of the any of the second virtual screens is updated.

In one embodiment, the output module 420 is configured to: acquire attribute information of the any of the second virtual screen when the display content of the any of the second virtual screen is updated; and display a display control element matching the attribute information of the second virtual screen, on the first virtual screen.

In one embodiment, the apparatus 400 further includes a first acquisition module (not shown in the drawings).

The first acquisition module is configured to acquire set mapping data when the display content of any of the second virtual screens is updated; wherein the mapping data reflects the position information and the attribute information of different virtual screens;

The determination module 410 is further configured to determine the position information of the second virtual screen according to the mapping data and the attribute information of the any of the second virtual screens;

The determination module 410 is further configured to determine the prompt identification information of the any of the second virtual screen based on the position information of the any of the second virtual screens;

The output module 420 is further configured to highlight the prompt identification information of the any of the second virtual screens.

In one embodiment, the apparatus 400 further includes a first receiving module, an updating module and a modification module (not shown in the drawings).

The first receiving module is configured to receive a first input for the display control element;

The updating module is configured to update a display position of the any of the second virtual screen in response to the first input;

The modification module is configured to modify the set mapping data when the display position of the any of the second virtual screens is updated; wherein the mapping data reflects the position information and the attribute information of different virtual screens;

The updating module is specifically configured to interchange the positions of the first virtual screen and the any of the second virtual screens.

In one embodiment, the apparatus 400 further includes a second acquisition module and a pause module (not shown in the drawings).

The second acquisition module is configured to acquire attribute information of an application operated on the first virtual screen in response to the first input;

The pause module is configured to pause the playing of the target video based on the application when the attribute information of the application is in the list of set application attribute;

The list of the set application attribute includes attribute information of a plurality of different video applications.

In one embodiment, the apparatus further includes a second receiving module (not shown in the drawings).

The second receiving module is configured to receive a second input for the any of the second virtual screen.

The output module is further configured to delete the first prompt information and stop highlighting the prompt identification information of the second virtual screen in response to the second input;

The second receiving module is specifically configured to receive a touch event of the user for the second virtual screen; receive a ray event sent by a controller for the second virtual screen; and receive a gesture event operated by the user to the second virtual screen.

According to an embodiment of the present disclosure, when part of the plurality of virtual screens are located in the field of view of the wearer of the head-mounted display device, the first virtual screen among the plurality of virtual screens can be used as the main display screen of the head-mounted display device, and when the display content of second virtual screens among the plurality of virtual screens is updated, although the second virtual screen may not be located in the field of view of the wearer, the first prompt information can be directly output on the first virtual screen, so that the user can quickly switch to the any of the second virtual screens based on the first prompt information.

### Device Embodiment

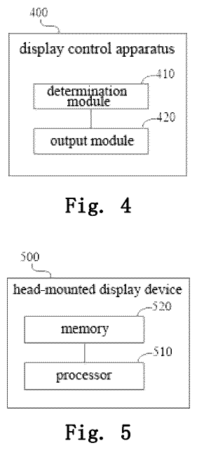

FIG. 5 is a schematic structure diagram of the hardware structure of a head-mounted display device according to an embodiment. As shown in FIG. 5, the head-mounted display device 500 includes a processor 510 and a memory 520.

The memory 520 may be configured to store executable computer instructions.

The processor 510 can be configured to execute the display control method according to the embodiment of the method disclosed herein under control of the executable computer instructions.

The head-mounted display device 500 may be the head-mounted display device 1000 as shown in FIG. 1, or may be a device having other hardware structures, which are not limited herein.

In another embodiment, the head-mounted display device 500 may include the above display control apparatus.

In one embodiment, each module of the above display control apparatus 400 can be implemented in a manner that the processor 510 executes the computer instructions stored in the memory 520.

According to the embodiment of the present disclosure, when part of the plurality of virtual screens are located in the field of vision of the wearer of the head-mounted display device, the first virtual screen among the plurality of virtual screens can be used as the main display screen of the head-mounted display device, and when the display content of second virtual screens among the plurality of virtual screens is updated, although the second virtual screen may not be located in the field of vision of the wearer, the first prompt information can be directly output on the first virtual screen, so that the user can quickly switch to the second virtual screen based on the first prompt information.

### Computer Readable Storage Medium

The embodiment of the present disclosure further provides a computer-readable storage medium in which computer instructions are stored. When the computer instructions are executed by a processor, the display control method provided by the embodiment of the present disclosure is executed.

The present disclosure may be a system, a method and/or a computer program product. The computer program product may include a computer-readable storage medium carrying computer-readable program instructions for allowing a processor to implement various aspects of the present disclosure.

A computer-readable storage medium may be a tangible device that can hold and store instructions used by an instruction execution device. A computer-readable storage medium may be, for example, but not limited to, an electrical storage device, a magnetic storage device, an optical storage device, an electromagnetic storage device, a semiconductor storage device, or any suitable combination of the above. More specific examples (a non-exhaustive list) of the computer-readable storage media include: a portable computer disk, a hard disk, a random access memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, a mechanical encoding device, such as a punch card or a raised structure in a groove in which instructions are stored, and any suitable combination of the above. The computer-readable storage medium used herein is not to be interpreted as a transient signal itself, such as a radio wave or other freely propagating electromagnetic wave, an electromagnetic wave propagating through a waveguide or other transmission medium (e.g., a light pulse passing through a fiber optic cable), or an electrical signal transmitted through a wire.

The computer-readable program instructions described herein can be downloaded to each computing/processing device from a computer-readable storage medium, or downloaded to an external computer or external storage device via a network, such as the Internet, a local area network, a wide area network, and/or a wireless network. The network can include copper transmission cables, optical fiber transmissions, wireless transmissions, routers, firewalls, switches, gateway computers, and/or edge servers. The network adapter card or network interface in each computing/processing device receives the computer-readable program instructions from the network and transmits the computer-readable program instructions for storage in the computer-readable storage medium in each computing/processing device.

The computer program instructions for performing the operations of the present disclosure may be assembly instructions, instruction set architecture (ISA) instructions, machine instructions, machine-dependent instructions, microcode, firmware instructions, state setting data, or source code or object code written in any combination of one or more programming languages, the programming languages includes object-oriented programming languages, such as Smalltalk, C++, etc., and conventional procedural programming languages, such as “C” language or similar programming languages. The computer-readable program instructions may be executed entirely on the user's computer, executed partially on the user's computer, executed as a separate software package, executed partially on the user's computer and executed partially on a remote computer, or executed entirely on a remote computer or server. In the case of a remote computer, the remote computer may be connected to the user's computer through any type of network, including a local area network (LAN) or a wide area network (WAN), or may be connected to an external computer (e.g., using an Internet service provider to connect through the Internet). In some embodiments, using the state information of the computer-readable program instructions to personalize an electronic circuit, such as a programmable logic circuit, a field programmable gate array (FPGA), or a programmable logic array (PLA), the electronic circuit may execute the computer-readable program instructions, thereby implementing various aspects of the present disclosure.

Various aspects of the present disclosure are described herein with reference to flowcharts and/or block diagrams of methods, devices (systems) and computer program products according to embodiments of the present disclosure. It should be understood that each box in the flowchart and/or block diagram and the combination of boxes in the flowchart and/or block diagram can be implemented by computer-readable program instructions.

These computer-readable program instructions can be provided to a processor of a general-purpose computer, a special-purpose computer, or other programmable data processing device, thereby producing a machine, so that when these instructions are executed by the processor of the computer or other programmable data processing device, a device that implements the functions/operations specified in one or more boxes in the flowchart and/or block diagram is generated. These computer-readable program instructions can also be stored in a computer-readable storage medium, and these instructions cause the computer, programmable data processing device, and/or other device to operate in a specific manner, so that the computer-readable medium in which the instructions are stored includes a manufactured product, which includes instructions for implementing various aspects of the functions/actions specified in one or more boxes in the flowchart and/or block diagram.

Computer-readable program instructions may also be loaded onto a computer, other programmable data processing apparatus, or other devices so that a series of operating steps are performed on the computer, other programmable data processing apparatus, or other devices to produce a computer-implemented process, thereby causing the instructions executed on the computer, other programmable data processing apparatus, or other devices to implement the functions/operations specified in one or more boxes in the flowchart and/or block diagram.

The flowcharts and block diagrams in the accompanying drawings show the possible architecture, functions and operations of the systems, methods and computer program products according to multiple embodiments of the present disclosure. In this regard, each box in the flowchart or block diagram can represent a module, a program segment or a part of an instruction, and the module, a program segment or a part of an instruction contains one or more executable instructions for realizing the specified logical function. In some alternative implementations, the functions marked in the box can also executed in an order different from the order marked in the accompanying drawings. For example, two consecutive boxes can actually be executed substantially in parallel, and they can sometimes be executed in the opposite order, depending on the functions involved. It should also be noted that each box in the block diagram and/or the flowchart, and the combination of the boxes in the block diagram and/or the flowchart can be implemented by a dedicated hardware-based system that performs the specified function or operation, or can be implemented by a combination of dedicated hardware and computer instructions. It is well known to those skilled in the art that it is equivalent to implement by hardware, implement by software, and implement by combining software and hardware.

The embodiments of the present disclosure have been described above, and the above description is exemplary, not exhaustive, and is not limited to the disclosed embodiments. Many modifications and changes will be apparent to those of ordinary skill in the art without departing from the scope and spirit of the described embodiments. The choice of terms used herein is intended to best explain the principles of the embodiments, practical applications, or technical improvements in the marketplace, or to enable other persons of ordinary skill in the art to understand the embodiments disclosed herein. The scope of the present disclosure is defined by the appended claims.

1. A display control method, wherein the method comprises:
using a first virtual screen among a plurality of virtual screens as a main display screen of a head-mounted display device, and determining whether display content of second virtual screens among the plurality of virtual screens is updated, wherein part of the plurality of virtual screens are located in a visual field area of a wearer of the head-mounted display device; and
outputting first prompt information on the first virtual screen when the display content of any of the second virtual screens is updated.

2. The method according to claim 1, wherein the determining whether the display content of any of the second virtual screens is updated comprises:
acquiring a current first display data frame and a latest second display data frame of the any of the second virtual screens;
comparing the first display data frame with the second display data frame to obtain a comparison result; and
when the comparison result indicates that there is a difference between the first display data frame and the second display data frame, indicating that the display content of the any of the second virtual screens is updated.

3. The method according to claim 1, wherein the outputting first prompt information on the first virtual screen when the display content of any of second virtual screens is updated comprises:
when the display content of the any of the second virtual screens is updated, acquiring attribute information of the any of the second virtual screens; and
displaying a display control element matching the attribute information of the any of the second virtual screens, on the first virtual screen.

4. The method according to claim 1, wherein the method further comprises:
when the display content of the any of the second virtual screens is updated, acquiring a set mapping data, wherein the mapping data reflects position information and attribute information of different virtual screens; and
determining position information of the any of the second virtual screens according to the mapping data and attribute information of the any of the second virtual screens;
determining prompt identification information of the any of the second virtual screens based on the position information of the any of the second virtual screens; and
highlighting the prompt identification information of the any of the second virtual screens.

5. The method according to claim 3, wherein after the outputting the first prompt information on the first virtual screen, the method further comprises:
receiving a first input for the display control element;
updating a display position of the any of the second virtual screens in response to the first input; and
when updating the display position of the any of the second virtual screens, modifying a set mapping data; wherein the mapping data reflects position information and attribute information of different virtual screens,
wherein, the updating the display position of the any of the second virtual screens in response to the first input includes: interchanging the display position of the any of the second virtual screens and a display position of the first virtual screen.

6. The method according to claim 5, wherein the method further comprises:
acquiring attribute information of an application operated on the first virtual screen in response to the first input; and
when the attribute information of the application is in a list of set application attributes, pausing playing of a target video based on the application,
wherein the list of set application attributes comprises attribute information of a plurality of different video applications.

7. The method according to claim 4, wherein the method further comprises:
receiving a second input for the any of the second virtual screens; and
in response to the second input, deleting the first prompt information, and stopping highlighting the prompt identification information of the any of the second virtual screens, wherein the receiving the second input for the any of the second virtual screens comprises one of:
receiving a touch event of a user on the any of the second virtual screens;
receiving a ray event sent by a controller to the any of the second virtual screens; and
receiving a gesture event operated by a user to the any of the second virtual screens.

8. A display control apparatus, wherein the apparatus comprises:
a determination module configured to use a first virtual screen among a plurality of virtual screens as a main display screen of a head-mounted display device, and determine whether display content of second virtual screens among the plurality of virtual screens is updated, wherein part of the plurality of virtual screens are located in a visual field area of a wearer of the head-mounted display device; and
an output module configured to output first prompt information on the first virtual screen when the display content of any of the second virtual screens is updated.

9. A head-mounted display device, wherein the head-mounted display device comprises:
a memory configured to store executable computer instructions; and
a processor configured to execute the display control method according to claim 1 under control of the executable computer instructions.

10. A computer-readable storage medium in which computer instructions are stored, wherein the computer instructions are executed by a processor to execute the display control method according to claim 1.
